(19) United States
(12) Patent Application Publication
(10) Pub. No.: US 2021/0191043 A1
(43) Pub. Date: Jun. 24, 2021

(54) PROBE OPTICAL FIBER AND OPTICAL FIBER LATERAL INPUT/OUTPUT DEVICE

(71) Applicant: NIPPON TELEGRAPH AND TELEPHONE CORPORATION, Tokyo (JP)

(72) Inventors: Takui UEMATSU, Musashino-shi, Tokyo (JP); Hidenobu HIROTA, Musashino-shi, Tokyo (JP); Hiroyuki IIDA, Musashino-shi, Tokyo (JP); Tetsuya MANABE, Musashino-shi, Tokyo (JP)

(73) Assignee: NIPPON TELEGRAPH AND TELEPHONE CORPORATION, Tokyo (JP)

(21) Appl. No.: 17/053,048

(22) PCT Filed: Apr. 26, 2019
(86) PCT No.: PCT/JP2019/018069

§ 371 Date: Nov. 4, 2020

(30) Foreign Application Priority Data
May 8, 2018 (JP) 2018-089911

(51) Int. Cl. G02B 6/28

(52) U.S. Cl. CPC G02B 6/2852

(57) ABSTRACT

An object of the present invention is to provide a probe optical fiber and a local-light coupling apparatus for an optical fiber that can input light with high efficiency without performing input efficiency measurement or probe alignment. The present invention is a probe optical fiber of which a tip is close to a bent part of a coated optical fiber disposed in a local-light coupling apparatus for an optical fiber, and which inputs and outputs light to and from the bent part of the coated optical fiber, wherein light emitted from the tip has a light intensity profile in which in the bent part of the coated optical fiber, relative to a light intensity in a center of an optical axis, a decrease in light intensity at a position separated by 20 μm from the optical axis is less than 17.6 dB.

### TECHNICAL FIELD

The present disclosure relates to a local-light coupling apparatus for an optical fiber that bends a coated optical fiber and inputs and outputs light through the side of an optical fiber.

### BACKGROUND ART

As techniques for inputting and outputting optical signals through an optical fiber without cutting the optical fiber, a local-light coupling technique for an optical fiber has been studied in which bending is applied to an existing optical fiber (input-side optical fiber), another optical fiber (probe optical fiber) is made to face the bent part from the side surface, an optical signal is injected from a tip end portion of the probe optical fiber, and an optical signal emitted from the input-side optical fiber is received at the tip end portion of the probe optical fiber (see, for example, Patent literature 1).

### CITATION LIST

### Patent Literature

Patent Literature 1: JP 2015-040916 A

### Non Patent Literature

Non Patent Literature 1: Uematsu et al., “Study for reducing bending loss of core contrast for optical fiber with local-light coupling technique”, Institute of Electronics, Information and Communication Engineers Communication Society Conference, 2015, B-13-12.
Non Patent Literature 2: Kawaso et al., “Study on probe fiber position fixation accuracy”, IEICE Technical Report, OFT2014-28, October 2014.
Non Patent Literature 3: T. Uematsu et. al., “High-efficiency light injection and extraction using fiber bending”, OFC2017, W2A.15, March 2017.
Non Patent Literature 4: Uematsu et al., “Study on local-light coupling technique for optical fiber directed to communication optical monitor on outside 8-branch splitter”, IEICE Technical Report, OFT2015-22, August 2015.

### SUMMARY OF THE INVENTION

### Technical Problem

To improve the input efficiency from the probe to the bending fiber, the beam emitted from the probe needs to be squeezed to couple the light into the core of the bending fiber (see, for example, Non Patent Literature 1). However, the input efficiency significantly decreases when axial offset occurs by squeezing the beam (Non Patent Literature 2, FIG. 6). For example, the input efficiency decreases by 5 dB due to an axial offset of approximately 10 μm. In particular, in the case of an optical fiber with a protective tube or tape fiber core, there is a possibility of axial offset of approximately tens of μm due to structural variation of each individual. Thus, in the case where light is input to these fiber cores, the probe needs to be aligned to the position where the input efficiency is obtained most.

However, in the case of a coated optical fiber used as a current line and inputting and outputting light to and from the bent coated optical fiber, there are difficulties in measuring the intensity of light input from the bent part (input efficiency measurement), and in aligning the probe to an optimal position. There is also a problem that the structure becomes complex because the probe needs to be mechanically moved when the probe is aligned to an optimal position.

Thus, to solve the problems described above, an object of the present disclosure is to provide a probe optical fiber and a local-light coupling apparatus for an optical fiber capable of inputting light with high efficiency without performing input efficiency measurement or probe alignment.

### Means for Solving the Problem

To achieve the object described above, the probe optical fiber according to the present disclosure has a gentle shape in the light intensity profile of light emitted from the tip of the probe optical fiber.

Specifically, the probe optical fiber according to the present disclosure is a probe optical fiber of which a tip is close to a bent part of a coated optical fiber disposed in a local-light coupling apparatus for an optical fiber, and which inputs and outputs light to and from the bent part of the coated optical fiber, wherein light emitted from the tip has a light intensity profile in which in the bent part of the coated optical fiber, relative to a light intensity in a center of an optical axis, a decrease in light intensity at a position separated by 20 μm from the optical axis is less than 17.6 dB.

In the related art, a single mode fiber, a double cladding fiber, or the like is used as an input/output probe optical fiber (see, for example, Non Patent Literature 3). The input light (emitted light from the probe optical fiber) is collected by the lens connected to the probe tip into the core of the bent part of the coated optical fiber, and the input efficiency is improved. As illustrated in FIG. 1, the intensity distribution of the light at the bent part of the coated optical fiber has a shape in which the light intensity peaks near the optical axis (the center axis of the probe optical fiber) of the input light and sharply decreases as the distance from the optical axis increases. Thus, when an axial offset occurs, the input efficiency is greatly reduced.

Contrary to the related art, the probe optical fiber according to the present invention has weak light collection of the input light and has the intensity distribution of the light at the bent part of the coated optical fiber in which the difference between the light intensity of the input light near the optical axis and the light intensity of the portion separated from the optical axis is reduced. Thus, the probe optical fiber according to the present disclosure can improve input efficiency tolerance to axial offset. Thus, the present disclosure can provide a probe optical fiber capable of inputting light with high efficiency without performing input efficiency measurement or probe alignment.

For example, the probe optical fiber is a multi-core fiber having a plurality of cores, propagates the same light through the plurality of cores and emits the light from the tip. Further, the probe optical fiber is a fiber bundle in which a plurality of single-core fibers are bundled, and propagates the same light through cores of the plurality of single-core fibers and emits the light from the tip.

At this time, it is preferable that any one of the cores is used to receive light leaking from the bent part of the coated optical fiber. Further, it is preferable that in a cross section, one of the cores is disposed at the center, and the other cores are disposed at positions of vertexes of a regular polygon around the center, and the core disposed in the center is used to receive light leaking from the bent part of the coated optical fiber.

For example, the probe optical fiber may be a large-diameter core fiber having a core diameter of 100 μm or greater.

A local-light coupling apparatus for an optical fiber according to the present disclosure includes: a first jig including a recess curved in a longitudinal direction with respect to a coated optical fiber, and a holding portion that holds the probe optical fiber which inputs and outputs light to and from the coated optical fiber provided with the bent part; and a second jig including a protrusion that curves in the longitudinal direction with respect to the coated optical fiber and sandwiches the coated optical fiber between the protrusion and the recess of the first jig.

The local-light coupling apparatus for an optical fiber includes the above-described probe optical fiber. Thus, the local-light coupling apparatus for an optical fiber can improve the input efficiency tolerance to the axial offset. Thus, the present invention can provide a local-light coupling apparatus for an optical fiber that can input light with high efficiency without performing input efficiency measurement or probe alignment.

### Effects of the Invention

The present disclosure can provide a probe optical fiber and a local-light coupling apparatus for an optical fiber that can input light with high efficiency without performing input efficiency measurement or probe alignment.

### BRIEF DESCRIPTION OF DRAWINGS

FIG. 1 is a diagram illustrating a light intensity distribution of light emitted from a probe optical fiber provided in a local-light coupling apparatus for an optical fiber in the related art at a bent part of the coated optical fiber.

FIG. 2 is a block diagram illustrating a local-light coupling apparatus for an optical fiber embodying the principles of the present invention.

FIG. 3 is a cross-sectional view of a probe optical fiber embodying the principles of the present invention.

FIG. 4 is a diagram illustrating the structure of the probe optical fiber embodying the principles of the present invention.

FIG. 5 is a diagram illustrating a light intensity distribution of light emitted from the probe optical fiber embodying the principles of the present invention.

FIG. 6 is a cross-sectional view of the probe optical fiber embodying the principles of the present invention.

FIG. 7 is a diagram illustrating the structure of the probe optical fiber embodying the principles of the present invention.

FIG. 8 is a cross-sectional view of a probe optical fiber embodying the principles of the present invention.

FIG. 9 is a diagram for explaining the structure of the probe optical fiber embodying the principles of the present invention.

FIG. 10 is a set of cross-sectional views of the probe optical fiber embodying the principles of the present invention.

FIG. 11 is a diagram illustrating a light intensity distribution of light emitted from the probe optical fiber embodying the principles of the present invention.

FIG. 12 is a diagram illustrating a light intensity distribution of light emitted from the probe optical fiber embodying the principles of the present invention.

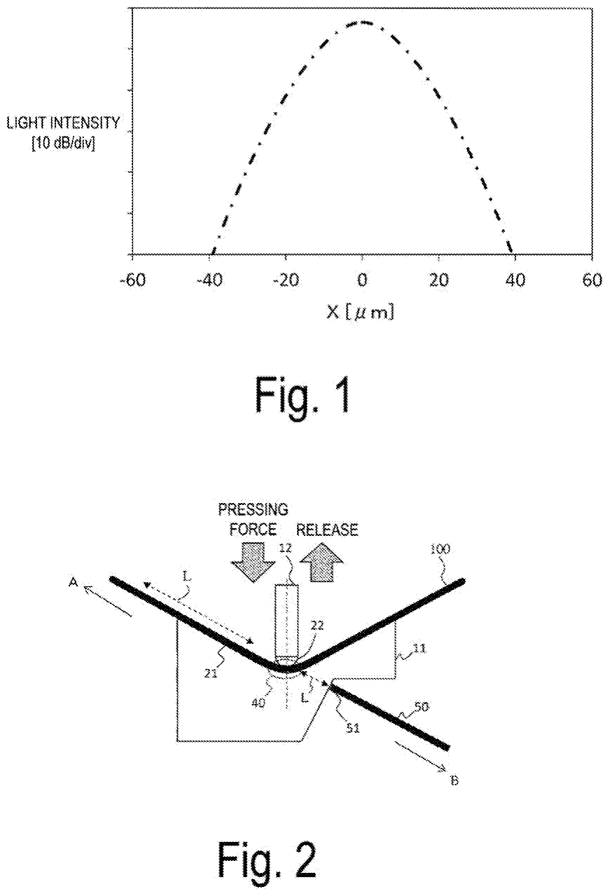

### DESCRIPTION OF EMBODIMENTS

Hereinafter, embodiments of the present invention will be described with reference to the drawings. The embodiments described below are examples of the present disclosure, and the present disclosure is not limited to the following embodiments. In this specification and the drawings, constituent elements having the same reference signs are assumed to be the same.

### Embodiment 1

FIG. 2 is a diagram illustrating a local-light coupling apparatus for an optical fiber according to the present embodiment. The local-light coupling apparatus for an optical fiber includes: a first jig 11 having a recess 21 that curves in a longitudinal direction with respect to the coated optical fiber 100 and a holding unit 51 that holds the probe optical fiber 50 that inputs and outputs the light L to and from the bent part 40 of the coated optical fiber 100; and a second jig 12 having a protrusion 22 that curves in a longitudinal direction with respect to the coated optical fiber 100 and sandwiches the coated optical fiber 100 between the second jig 12 and the recess 21 of the first jig 11.

The local-light coupling apparatus for an optical fiber sandwiches the coated optical fiber 100 between the first jig 11 and the second jig 12. Then, the local-light coupling apparatus for an optical fiber applies a pressing force to the second jig 12 to bring the second jig 12 closer to the first jig 11, and bends the coated optical fiber 100 at the protrusion 22 along the recess 21 of the first jig 11 to form the bent part 40. On the other hand, the local-light coupling apparatus for an optical fiber releases the pressing force, thereby separating the first jig 11 and the second jig 12 and eliminating the bending of the coated optical fiber 100.

The probe optical fiber 50 emits light from B from the tip into the bent part 40 of the coated optical fiber 100, and the light enters the coated optical fiber 100 from the bent part 40 and propagates in the direction A. Further, a portion of the light propagating through the optical fiber 100 from the direction A leaks from the bent part 40. The probe optical fiber 50 receives this leaked light at the tip and propagates in the direction B. For example, the distance between the tip of the probe optical fiber 50 and the bent part 40 is approximately 1 to 2 mm.

### Embodiment 2

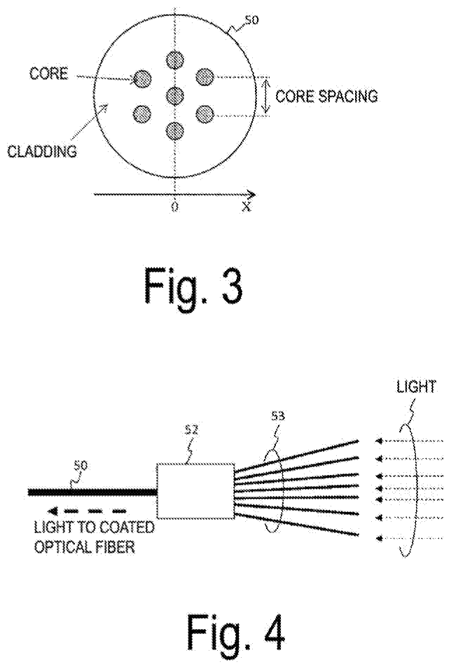

FIG. 3 is a cross-sectional view of the probe optical fiber 50. The probe optical fiber 50 is a multi-core fiber having a plurality of cores, and propagates the same light through the plurality of cores and emits the light from the tip. FIG. 3 is an example of a 7-core multi-core fiber. For example, as in FIG. 4, the probe optical fiber 50 may use a multi-core fiber fan-in 52 to input and output light from the plurality of single-core fibers 53 to and from each core of a multi-core fiber. FIG. 4 is an example of a 7-core multi-core fiber of the probe optical fiber 50.

In the probe optical fiber 50, all cores may be used for inputting and outputting light to and from the coated optical fiber 100. On the other hand, in the probe optical fiber 50, a certain core may be used as an output for receiving the leaked light from the coated optical fiber 100. For example, when a circulator or the like is installed in a single-core fiber 53 corresponding to the output core, the core can be used for input/output.

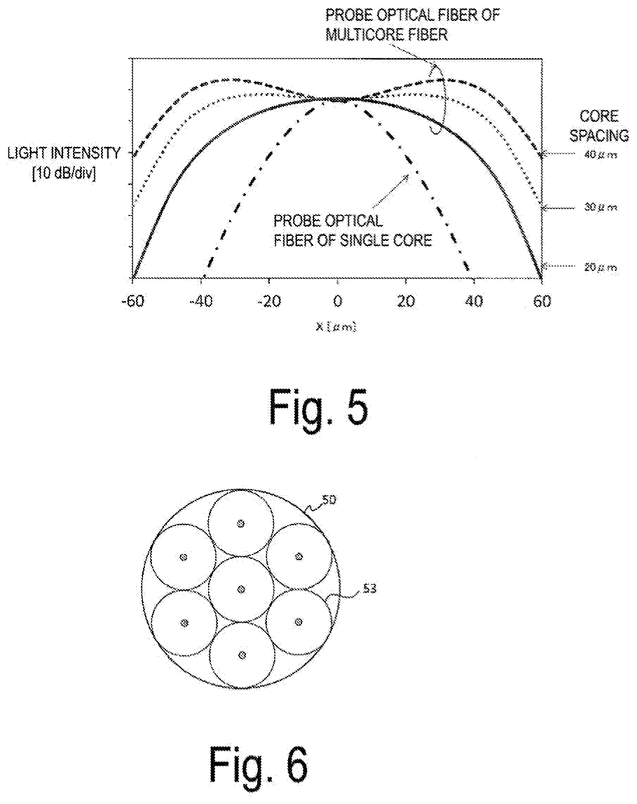

FIG. 5 is a diagram illustrating the intensity distribution of light emitted from the tip of the probe optical fiber 50 of the multi-core fiber and input into the bent part 40 of the coated optical fiber 100. In this evaluation, the number of cores is 7, and the disposition of the core is as illustrated in FIG. 3. In FIG. 5, the horizontal axis is the x-axis with reference to the center of the probe optical fiber 50 in FIG. 3. Here, the diameter of each core is 8 μm, the number of apertures is 0.14, and the wavelength is 1550 nm. In addition, the distance from the tip of the probe optical fiber 50 to the bent part 40 of the coated optical fiber 100 is 2 mm. Similar to the single-core probe optical fiber described in Non Patent Literature 2, a refractive index distribution lens connected to the tip of the probe optical fiber 50 has been used.

This evaluation illustrates the intensity distribution when the core spacing of the probe optical fiber 50 is 20, 30, 40 μm. In comparison, the intensity distribution of input light emitted from a single-core probe optical fiber described in Non Patent Literature 2 is also illustrated (dot-dash line). Note that while the intensity distribution in the X-axis direction is illustrated in FIG. 5, the same result is obtained on any axis as long as the axis is a horizontal axis with respect to the probe optical fiber cross-section.

The probe optical fiber 50 has a higher intensity distribution relative to a wide range of X as compared to a single-core probe optical fiber. Specifically, in the probe optical fiber 50, the light emitted from the tip has a light intensity profile in which a decrease in light intensity at a position 20 μm away from the optical axis is less than 17.6 dB relative to the light intensity at the center of the optical axis, at the bent part 40 of the coated optical fiber 100 separated by 2 mm.

Such a light intensity profile means that the decrease in input efficiency is small even when the probe optical fiber 50 is not aligned to the optimal position and axial offset has occurred. It can also be seen that the larger the core spacing, the wider the light intensity distribution and the greater the tolerance to axial offset.

### Embodiment 3

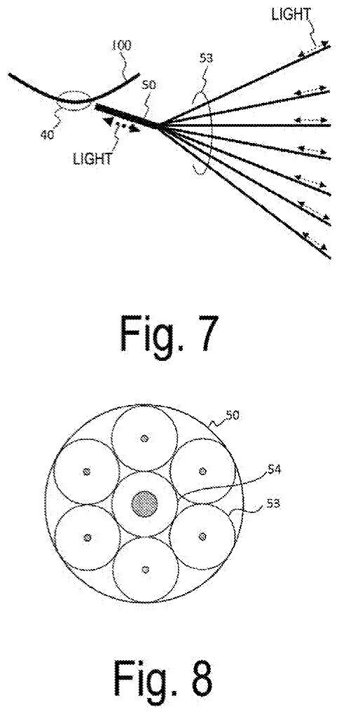

FIG. 6 is a cross-sectional view of the probe optical fiber 50. The probe optical fiber 50 is a fiber bundle in which a plurality of single-core fibers 53 are bundled, and propagates the same light through cores of the plurality of single-core fibers 53 and emits the light from the tip. For example, as illustrated in FIG. 7, the probe optical fiber 50 is a probe optical fiber 50 with seven single-core fibers 53 being bundled together on one end side. The other ends of the single-core fibers 53 are not bundled, and are connected to light sources or light receivers.

Because the fiber bundles are configured by bundling optical fibers in the related art, a multi-core fiber fan-in is unnecessary and low-cost compared to the case of the multi-core fiber of the second embodiment. In addition, it is easy to set the probe optical fiber 50 because selecting one core fiber makes it possible to select which core is used to receive the leaked light and which core is used to input light into the coated optical fiber.

The light intensity distribution of the probe optical fiber 50 of the present embodiment is also as illustrated in FIG. 5. The core spacing that affects tolerance to axial offset depends on the diameter of the single-core fiber 53. The core spacing is 125 μm in a typical single-mode fiber or the like. Further, the core spacing can be further reduced (for example, 80 μm) using the fine diameter fiber.

### Embodiment 4

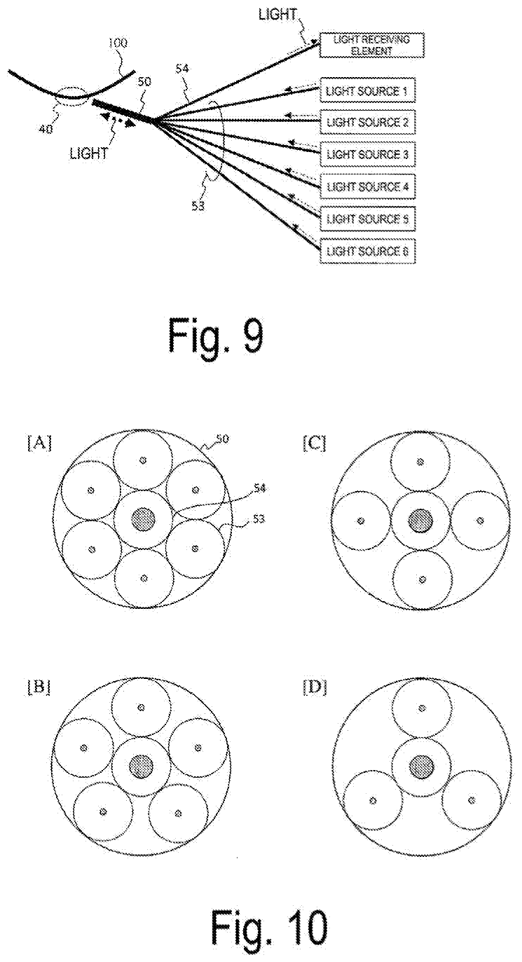

In the probe optical fibers 50 described in Embodiments 2 and 3, any one of the cores may be used to receive light leaking from the bent part 40 of the coated optical fiber 100. FIG. 8 illustrates a single-core fiber 54 centered in the probe optical fiber 50 of the fiber bundle described in Embodiment 3 which is a large-diameter fiber such as a double cladding fiber. A large-diameter fiber can be used to receive a large amount of leaked light from the bent part 40, and the light receiving efficiency (coupling efficiency) is improved compared to the probe optical fiber 50 of FIG. 6. For this reason, it is preferable to connect the light source and the light receiving element as in FIG. 9.

The present embodiment has been described as the case where the probe optical fiber 50 is a fiber bundle, but the same applies to a case where the probe optical fiber 50 is a multi-core fiber.

### Embodiment 5

In the probe optical fibers 50 described in Embodiments 2 and 3, in a cross section, one of the cores may be disposed at the center, and the other cores may be disposed at positions of vertexes of a regular polygon around the center, and the core disposed in the center may be used to receive light leaking from the bent part 40 of the coated optical fiber 100.

FIG. 10 is a set of cross-sectional views of probe optical fibers 50 in which a core (central core) that receives the leaked light from the bent part 40 is disposed at the center, and cores (outer cores) that input the light to the bent part 40 are disposed at positions of vertexes of a regular polygon around the central core. FIG. 10[A] is a cross-sectional view of a probe optical fiber 50 in which outer cores are disposed at vertexes of a regular hexagonal shape (a hexagonal close-packed structure), FIG. 10[B] is a cross-sectional view of a probe optical fiber 50 in which outer cores are disposed at vertexes of a regular pentagon, FIG. 10[C] is a cross-sectional view of a probe optical fiber 50 in which outer cores are disposed at vertexes of a regular square, and FIG. 10[D] is a cross-sectional view of a probe optical fiber 50 in which outer cores are disposed at vertexes of a regular triangle.

For the fiber (core) arrangement, it is desirable to arrange the outer cores symmetrically with respect to the central core as in FIG. 10 (in the case of n cores, a regular n−1 polygon). With this arrangement, because the light beams emitted from the outer cores overlap, and the central axis of the intensity distribution of the incoming beam to the coated optical fiber matches the center axis of the probe optical fiber 50, the optimal probe alignment positions match in the incoming beam and the leaked light, and the maximum input/output efficiency is obtained for both input and output.

As in FIG. 10A, a structure in which the central core is used to receive leaked light is desirable as a hexagonal close-packed structure. With this structure, the incoming beams emitted from the six outer cores overlap, and an incoming beam equivalent to that emitted from all seven cores is obtained. FIG. 11 is a diagram illustrating the intensity distribution of light which emitted from the six outer cores and input to the coated optical fiber 100 in the probe optical fiber 50 with a hexagonal close-packed structure. The horizontal axis is the x-axis based on the center of the probe optical fiber 50, where the core diameter is 8 μm and the number of apertures is 0.14. The solid line and the dashed line indicate the light intensity distributions when the core spacing is 125 μm and the core spacing is 80 μm, respectively. As a comparison, the light intensity distribution of a single-core probe optical fiber in the related art is also indicated by a dot-dash line.

From FIG. 11, it can be seen that the probe optical fiber 50 with a hexagonal close-packed structure has a lower light intensity than the probe optical fiber in the related art in the vicinity of the center, but it is possible to avoid a reduction in light intensity in a wide range of X, and to maintain input efficiency. Thus, it can be seen that tolerance to axial offset is significantly improved. Further, for output efficiency, high output efficiency can be achieved and high tolerance to axial offset can be obtained by using a center core as an output and using the large-diameter core fiber described in Non Patent Literature 4. As described above, the probe optical fiber 50 with a hexagonal close-packed structure can achieve a high tolerance to axial offset in the input to the coated optical fiber 100 and output from the coated optical fiber 100.

Note that in the present embodiment, the probe optical fiber 50 of the fiber bundle is described, but the same applies to the probe optical fiber 50 of the multi-core fiber. Further, the same also applies to the case where the number of the outer cores is 7 or greater, the arrangement of the cores is changed or the fiber array is used.

### Embodiment 6

The probe optical fiber 50 of the present embodiment is a large-diameter core fiber having a core diameter of 100 μm or greater. The probe optical fibers 50 described in Embodiments 2 to 5 are multi-core fibers or fiber bundles, and the light in which the output light from each core is overlapped is used as input light into the coated optical fiber 100. Light corresponding to the overlaid intensity distribution of the probe optical fibers 50 described in Embodiments 2 to 5 can be output even by using the fiber of one large-diameter core (large-diameter core fiber).

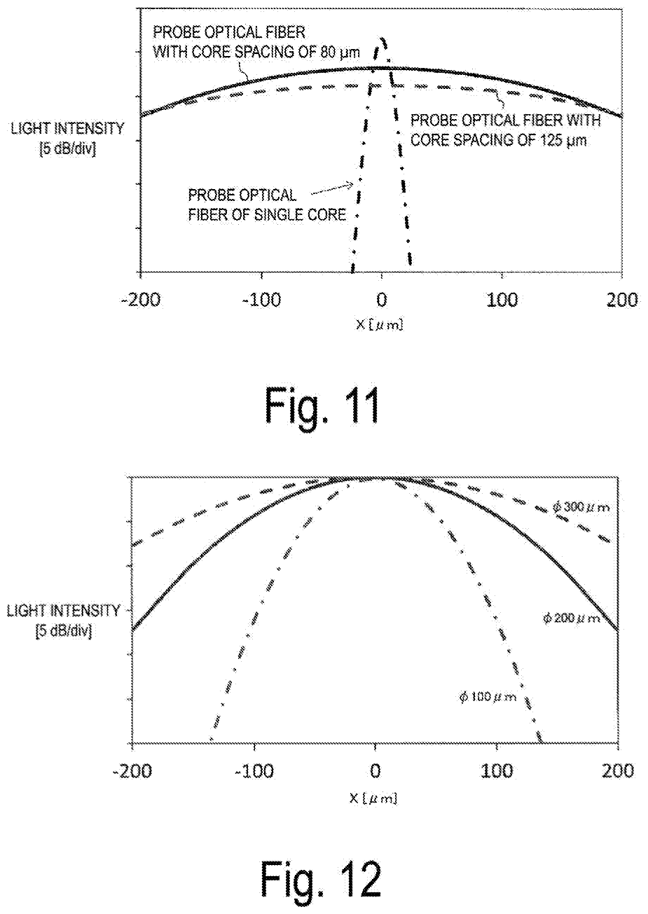

FIG. 12 is a diagram illustrating an intensity distribution of light output from the probe optical fiber 50 relative to a core diameter of a large-diameter core fiber. The dot-dash line, the solid line, and the dashed line indicate light intensity distributions with a core diameter of 100 μm, 200 μm, and 300 μm, respectively. As illustrated in FIG. 12, it can be seen that increasing the core diameter spreads the light intensity distribution and improves the input efficiency tolerance to axial offset.

### Effects of the Invention

The probe optical fiber according to the present disclosure emits light from a plurality of cores to make a light intensity profile smoother than that of light emitted from a single-core fiber in the related art (by increasing the total number of apertures), thereby enabling a local-light coupling apparatus for an optical fiber to have improved tolerance of input efficiency to axial offset and keep stable input/output efficiency.

The probe optical fiber according to the present disclosure can input and output light to a coated optical fiber (optical fiber with a protective tube, tape core, or the like) that does not avoid axial offset of approximately tens of μm due to structural variation with high efficiency without performing alignment.

### REFERENCE SIGNS LIST

11 First jig
12 Second jig
21 Recess
22 Protrusion
40 Bent part
50 Probe optical fiber
51 Holding portion
52 Multi-core fiber fan-in
53 Single-core fiber
54 Single-core fiber
100 Coated optical fiber

1. A probe optical fiber of which a tip is close to a bent part of a coated optical fiber disposed in a local-light coupling apparatus for an optical fiber, and which inputs and outputs light to and from the bent part of the coated optical fiber,
wherein light emitted from the tip has a light intensity profile in which in the bent part of the coated optical fiber, relative to a light intensity in a center of an optical axis, a decrease in light intensity at a position separated by 20 μm from the optical axis is less than 17.6 dB.

2. The probe optical fiber according to claim 1, wherein the probe optical fiber is a multi-core fiber having a plurality of cores, and propagates the same light through the plurality of cores and emits the light from the tip.

3. The probe optical fiber according to claim 1, wherein the probe optical fiber is a fiber bundle in which a plurality of single-core fibers are bundled, and propagates the same light through cores of the plurality of single-core fibers and emits the light from the tip.

4. The probe optical fiber according to claim 2, wherein any one of the cores is used to receive light leaking from the bent part of the coated optical fiber.

5. The probe optical fiber according to claim 2,
wherein in a cross section, one of the cores is disposed at the center, and the other cores are disposed at positions of vertexes of a regular polygon around the center, and
the core disposed in the center is used to receive light leaking from the bent part of the coated optical fiber.

6. The probe optical fiber according to claim 1, wherein the probe optical fiber is a large-diameter core fiber having a core diameter of 100 μm or greater.

7. A local-light coupling apparatus for an optical fiber comprising:
a first jig including a recess curved in a longitudinal direction with respect to a coated optical fiber, and a holding portion configured to hold the probe optical fiber according to claim 1 which inputs and outputs light to and from the coated optical fiber provided with the bent part; and
a second jig including a protrusion configured to curve in the longitudinal direction with respect to the coated optical fiber and sandwich the coated optical fiber between the protrusion and the recess of the first jig.
